(19) United States
(12) Patent Application Publication
(10) Pub. No.: US 2008/0002891 A1
(43) Pub. Date: Jan. 3, 2008

(54) Road sign determination apparatus, method and program

(76) Inventor: Norimasa Shibata, Tokyo (JP)

Correspondence Address: NIXON & VANDERHYE, PC, 901 NORTH GLEBE ROAD, 11TH FLOOR, ARLINGTON, VA, 22203, US

(21) Appl. No.: 11/819,698

(22) Filed: Jun. 28, 2007

(30) Foreign Application Priority Data
Jun. 30, 2006 (JP) 2006-182196

(51) Int. Cl. G06K 9/62

(52) U.S. Cl. 382/209

(57) ABSTRACT

A road sign determination apparatus executes image recognition of image data of a road sign shot with using a camera mounted on a field survey vehicle to determine the road sign. Particularly, it is preferably used for determination of a sign “DO NOT ENTER OTHER THAN DESIGNED DIRECTION”. The image recognition is executed by matching of a prepared template and the image data of the road sign. The template used for the image recognition includes a basic template formed by a figure formed by combining a circle of a sign frame and a single arrow. The outline of the road sign subjected to the determination can be obtained by the first matching with using the basic template. In accordance with the result of the first matching, the used sign template is limited. Substantially, the second matching is executed. Thereby, the determination process can be efficiently and rapidly executed.

### BACKGROUND OF THE INVENTION

1. Field of the Invention

The present invention relates to a method of determining a road sign by an image recognition process.

2. Description of Related Art

Map data used in a car navigation apparatus and an application operating on a PC and displaying a map includes road sign data. The road sign data is obtained by executing an image recognition process to image data obtained by taking a picture of a road sign provided in an actual road. Such an example that the image of the road sign is shot with using an on-vehicle camera and the road sign is extracted by the image recognition process is disclosed in Japanese Patent Applications Laid-open under No. 2000-293670 and No. 2003-123197.

The above determination of the road sign by the image recognition is executed by matching a prepared template corresponding to an actual road sign and the shot image.

However, a sign “DO NOT ENTER OTHER THAN DESIGNED DIRECTION” includes many kinds of patterns having plural arrows indicating travelable directions, which are complexly arranged. Therefore, if templates corresponding to all of the actual road signs are prepared and the matching of all the templates and the image data is executed, a process time problematically becomes extremely long.

### SUMMARY OF THE INVENTION

The present invention has been achieved in order to solve the above problem. It is an object of this invention to provide a road sign determination method capable of efficiently executing image recognition of an image of a road sign in a short process time and determining a kind of road sign.

According to one aspect of the present invention, there is provided a road sign determination apparatus including: an image recognition unit which executes image recognition of image data of a road sign with using a prepared template; and a determination unit which determines a road sign corresponding to the image data based on a result of the image recognition, wherein the template includes a basic template formed by a figure formed by combining a circle of a sign frame and a single arrow.

The above road sign determination apparatus executes the image recognition of the image data of the road sign shot by a camera mounted on a field survey vehicle and determines the road sign. Particularly, it is preferably used for the determination of the sign “DO NOT ENTER OTHER THAN DESIGNED DIRECTION”. The image recognition is executed by matching of the prepared template and the image data of the road sign. The template used for the image recognition includes the basic template formed by the figure formed by combining the circle of the sign frame and the single arrow. The sign “DO NOT ENTER OTHER THAN DESIGNED DIRECTION” is formed by the figure having one or plural arrow(s) indicating travelable direction(s). Thus, with using the basic template including the sign frame and the single arrow, the outline of the road sign subjected to the determination can be obtained and the determination process can be efficient.

In a manner of the above road sign determination apparatus, the image recognition unit may include: a first matching unit which executes matching by relatively rotating the basic template by a predetermined angle with respect to the image data, and obtains matching results in plural angle areas; and a second matching unit which executes matching with using a sign template corresponding to an actual road sign in accordance with the matching result.

In this manner, the outline of the subjected road sign image is obtained by the first matching with using the basic template. Based on it, the second matching with using the sign template can be efficient and the process time thereof can be shortened.

In a preferred example, the second matching unit may execute the matching with using the sign template only in the angle area in which the matching equal to or larger than a predetermined level is obtained in the matching result. In another preferred example, the second matching unit may limit the sign template used in the second matching based on a number of matching obtained in the matching result. By the methods, the second matching with using the plural sign templates can be efficient and rapid.

Additionally, in a preferred example, the basic template may include plural templates having same circle sizes of the sign frames and different arrow sizes. Thereby, the accuracy of the first matching to the signs having different arrow sizes can be ensured.

According to another aspect of the present invention, there is provided a road sign determination method including: an image recognition step which executes image recognition of image data of a road sign with using a prepared template; and a determination step which determines a road sign corresponding to the image data based on a result of the image recognition, wherein the template includes a basic template formed by a figure formed by combining a circle of a sign frame and a single arrow. By this method, the outline of the road sign subjected to the determination can be obtained with using the basic template including the sign frame and the single arrow, too. The determination process can be efficient.

According to still another aspect of the present invention, there is provided a road sign determination program, executed on a computer and making the computer function as: an image recognition unit which executes image recognition of image data of a road sign with using a prepared template; and a determination unit which determines a road sign corresponding to the image data based on a result of the image recognition, wherein the template includes a basic template formed by a figure formed by combining a circle of a sign frame and a single arrow. By executing the above program on the computer, the above road sign determination apparatus can be formed.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIGS. 1A to 1E show examples of a road sign and a sign template;

FIGS. 2A to 2D show examples of the road sign and a basic template;

FIGS. 3A and 3B are diagrams for explaining a matching process with using the basic template;

FIG. 4 shows a table showing an example of a matching result with using the basic template;

FIG. 5 is a configuration diagram of a sign information producing apparatus according to an embodiment;

FIG. 6 is a functional block diagram of the sign information producing apparatus;

FIG. 7 is a flow chart of a sign determination process; and

FIGS. 8A to 8C are tables showing examples of storage contents of a sign determination result, a traveling coordinate and sign information.

### DETAILED DESCRIPTION OF THE PREFERRED EMBODIMENTS

Now, a preferred embodiment of the present invention will be described below with reference to the attached drawings.

### (Road Sign Determination Method)

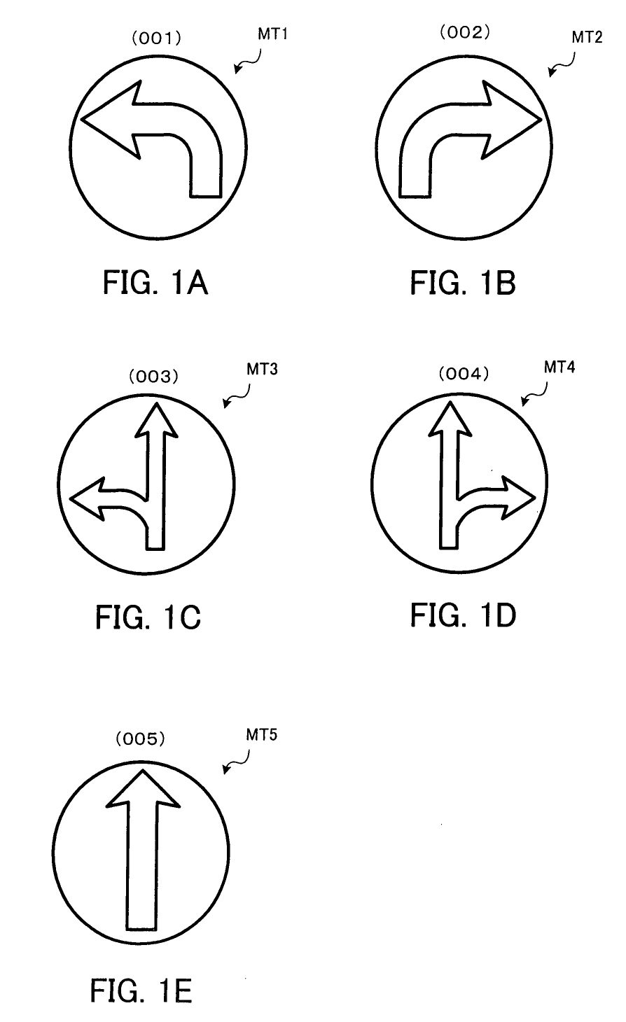

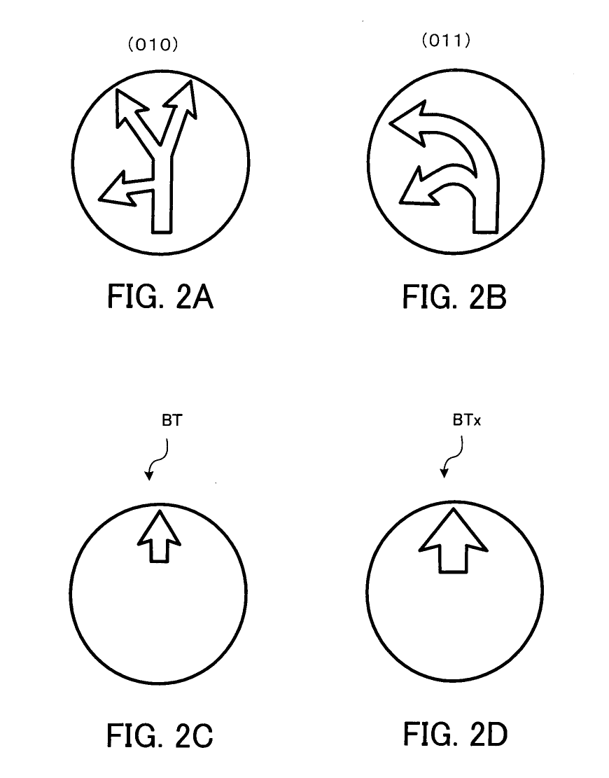

First, a description will be given of a determination method of the road sign according to an embodiment of the present invention. The method of this embodiment is mainly applied to a sign “DO NOT ENTER OTHER THAN DESIGNED DIRECTION” out of various kinds of road signs. Examples of the sign “DO NOT ENTER OTHER THAN DESIGNED DIRECTION” are shown in FIGS. 1A to 1E and FIGS. 2A and 2B. As shown, the sign “DO NOT ENTER OTHER THAN DESIGNED DIRECTION” is basically a figure indicating a travelable direction by an arrow. When the travelable direction is one or two direction(s) and corresponds to “STRAIGHT FORWARD” or “LEFT or RIGHT TURN”, the sign figure becomes a comparatively simple combination pattern of the arrows, as shown in FIGS. 1A to 1E. Meanwhile, when the travelable direction is equal to or larger than three directions and/or different from “STRAIGHT FORWARD” and “LEFT or RIGHT TURN”, the figure becomes comparatively special, as shown in FIGS. 2A and 2B. Numeral values, e.g., (001), shown in FIGS. 1A to 1E and FIGS. 2A and 2B, are sign codes showing the sign “DO NOT ENTER OTHER THAN DESIGNED DIRECTION” formed into each of the shapes.

The determination of the road sign is performed by the image recognition process with using the image data obtained by shooting the actual road sign and the prepared template. Namely, when the matching degree of the image data and the template is equal to or larger than a predetermined level, it is determined that the road sign of the image data is the road sign corresponding to the template. Thus, if the templates corresponding to various kinds of actual road signs are prepared and the matching process is executed to all of them, the sign can be basically determined, no matter what pattern the sign has. However, actually there exist special pattern signs shown in FIGS. 2A and 2B, for example. Therefore, if the templates corresponding to all of them are prepared and the matching process is executed, it takes a long time to execute the recognition process of the road signs.

Hence, in this embodiment, a basic template BT shown in FIG. 2C is used. Since the sign “DO NOT ENTER OTHER THAN DESIGNED DIRECTION” is basically formed by combining the arrows, the basic template BT is formed by the figure including the circle showing the sign frame and the single arrow arranged therein. As shown in FIG. 2C, the basic template BT includes only one arrow. Preferably, the arrow is formed into a shape of only an arrowhead part, and the length of the arrow is at least shorter than the radius of the circle showing the sign frame. This is because the matching is executed by rotating the basic template BT, which will be explained later.

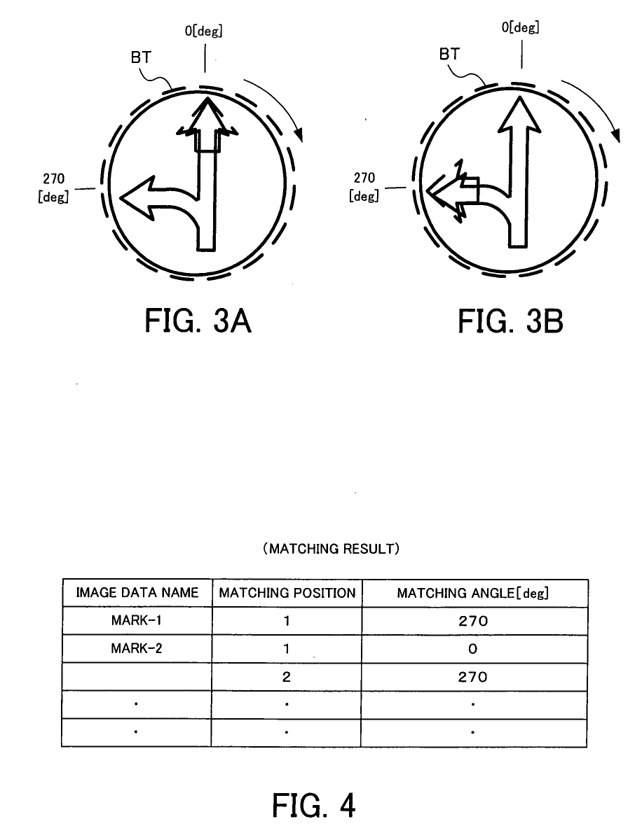

First, the recognition process with using the basic template BT is executed in the recognition process of the road sign. Concretely, while the basic template is relatively rotated with respect to the road sign image subjected to the determination, the matching is executed, which is also referred to as “first matching”. FIGS. 3A and 3B show examples in such a case that the road sign image is the sign shown in FIG. 1C. It is prescribed that a predetermined direction of the road sign image (straight forward arrow direction in this example) is a reference direction (rotation angle 0 degree), and the road sign image is fixed. In this state, while the basic template BT is rotated by the predetermined angle, the matching is executed. In the example shown in FIGS. 3A and 3B, first, the matching is established in the reference direction (i.e., rotation angle 0 degree) as shown in FIG. 3A, and next, the matching is established again in the rotation angle 270 degree direction as shown in FIG. 3B. That the matching is established means that the matching degree of the road sign image and the basic template BT becomes larger than the predetermined level.

In this manner, FIG. 4 shows the result of the matching with the road sign image during the rotation of the basic template BT. The matching result includes the position at which the matching is established, and the relative rotation angle of the basic template BT with respect to the road sign image at this time, for each image data of the road sign image. In the example shown in FIG. 4, image data “MARK-1” corresponds to the sign shown in FIG. 1A, and image data “MARK-2” corresponds to the sign shown in FIG. 1C and FIGS. 3A and 3B. Based on the matching result with using the basic template BT, the outline of the road sign image subjected to the determination can be figured out to some extent.

The first matching is executed with using the basic template in this manner. Subsequently, matching is executed with using a template (referred to as “sign template”) MT corresponding to the actual road sign, which is also referred to as “second matching”. In the second matching, the result of the first matching is used. In this embodiment, it is prescribed that, since the five typical signs shown in FIGS. 1A to 1E are frequently used in the actual road, correspondent sign templates MT1 to MT5 are prepared. Meanwhile, it is prescribed that, since the signs shown in FIGS. 2A and 2B are not frequently used in the actual road, they are special signs and sign templates therefor are not prepared.

A description will be given of a first method of using the first matching result when the second matching is executed. In this method, the matching position of the first matching result is used. For example, if the matching result shown in FIG. 4 is obtained by the first matching, since the sign corresponding to the image data “MARK-1” is a figure including a single arrow because the number of the matching position is one, it can be guessed that the sign is one of the signs shown in FIGS. 1A, 1B and 1E. Therefore, in the second matching, only the sign templates MT1, MT2 and MT5 shown in FIGS. 1A, 1B and 1E are used. In addition, since the sign corresponding to the image data “MARK-2” is a figure including two arrows because the number of the matching positions is two, it can be guessed that the sign is shown in FIG. 1C or 1D. Therefore, in the second matching, only the sign templates MT3 and MT4 are used. In this case, the second matching is executed to the entire figure of the subjected road sign image and the entire figure of the sign template.

By using the first matching result, it becomes unnecessary that all of five sign templates shown in FIGS. 1A to 1E are used in the second matching, and the time necessary for the entire road sign determination process can be shortened.

Next, a description will be given of a second method of using the first matching result when the second matching is executed. In this method, the matching angle of the first matching result is used. When the matching result shown in FIG. 4 is obtained in the first matching, the matching in the image data “MARK-1” is established at the matching angle 270 degree. Thus, in the second matching, the matching is executed only within a predetermined angle range around the matching angle 270 degree with using the five sign templates shown in FIGS. 1A to 1E. “Predetermined angle range” is predetermined within the range of the rotation angle±10 degree, for example. Namely, the matching of the entire figure of the image data and the entire figure of the sign templates is not executed, but the matching of the angle range of 260-280 degree of the image data “MARK-1” and the angle range of 260-280 degree of each of the sign templates is executed. In the case of the image data “MARK-2” shown in FIG. 4, the matching is executed only within the predetermined angle ranges around the matching angles 0 degree and 270 degree, respectively. Thereby, even when the matching with all kinds of sign templates is executed, the process time can be shortened by the amount of the limited area subjected to the matching operation.

It is noted that, in the second matching, both of the above-mentioned first and second methods may be executed.

As described above, in this embodiment, first, the first matching with using the basic template is executed, and based on the result, the second matching with using the sign template is executed. Hence, in accordance with the result of the first matching, the amount of the operation process in the second matching can be reduced, and the image recognition process can be efficient. Further, the process time can be shortened.

As shown in FIGS. 1A to 1E, when the signs capable of traveling in the one direction, shown in FIGS. 1A, 1B and 1E, and the signs capable of traveling in the two directions, shown in FIGS. 1B and 1D, are compared, the arrow sizes are actually different. Thus, in the first matching, two kinds of basic templates, i.e., a large-sized one and a small-sized one, may be used as shown in FIGS. 2C and 2D. Alternatively, the matching may be executed for plural times with changing only the arrow size in the basic template. Thereby, the accuracy of the first matching can be enhanced.

### (Sign Information Producing Apparatus)

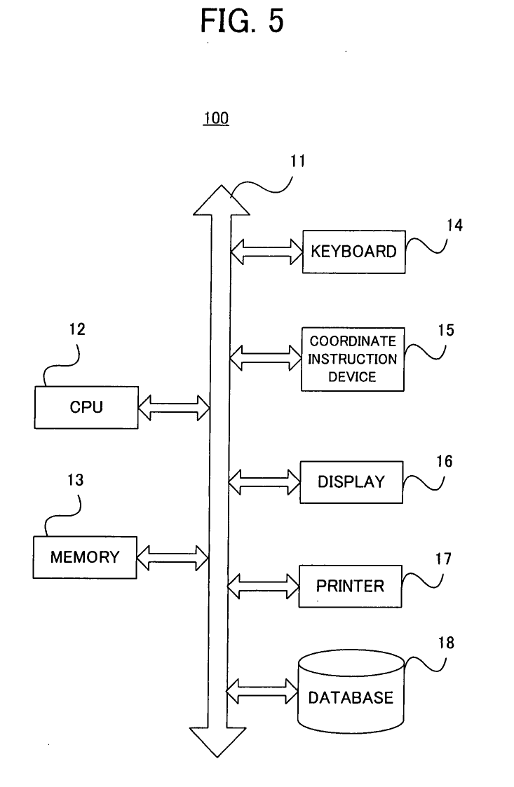

FIG. 5 shows a schematic configuration of the sign information producing apparatus 100 to which the road sign determination method according to the embodiment of the present invention is applied. The sign information producing apparatus 100, formed by a personal computer, includes a system bus 11, a CPU (Central Processing Unit) 12, a memory 13, a keyboard 14, a coordinate instruction device 15 such as a mouse, a display 16, a printer 17 and a database 18, for example. The keyboard 14 and the coordinate instruction device 15 are input devices. Additionally, the display 16 and the printer 17 are output devices. The CPU 12 controls the entire sign information producing apparatus 100 and the input/output devices.

The CPU 12, the memory 13 and the database 18 are connected to the system bus 11. The keyboard 14, the coordinate instruction device 15, the display 16 and the printer 17 are also connected to the system bus 11 via an interface (not shown). Road sign determination program according to this embodiment is stored in the memory 13. In addition, the memory 13 is also used as a work memory.

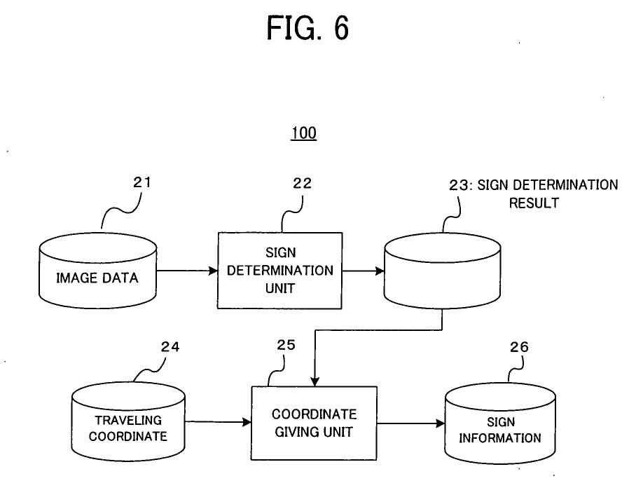

FIG. 6 is a functional block diagram of the sign information producing apparatus 100. The sign information producing apparatus 100 is functionally formed by an image data storage unit 21, a sign determination unit 22, a sign determination result storage unit 23, a traveling coordinate storage unit 24, a coordinate giving unit 25 and a sign information storage unit 26. When the CPU 12 shown in FIG. 5 executes program stored in the memory 13, the sign determination unit 22 and the coordinate giving unit 25 are realized. The image data storage unit 21, the sign determination result storage unit 23, the traveling coordinate storage unit 24 and the sign information storage unit 26 can be formed in the database 18 shown in FIG. 5.

A description will be given of the sign information producing process of this embodiment, below.

The image data storage unit 21 stores the image data obtained by shooting the actual road sign with using the camera. It is prescribed that data names such as “MARK-1” and “MARK-2” are given to each of the image data. Each of the image data is transmitted to the sign determination unit 22.

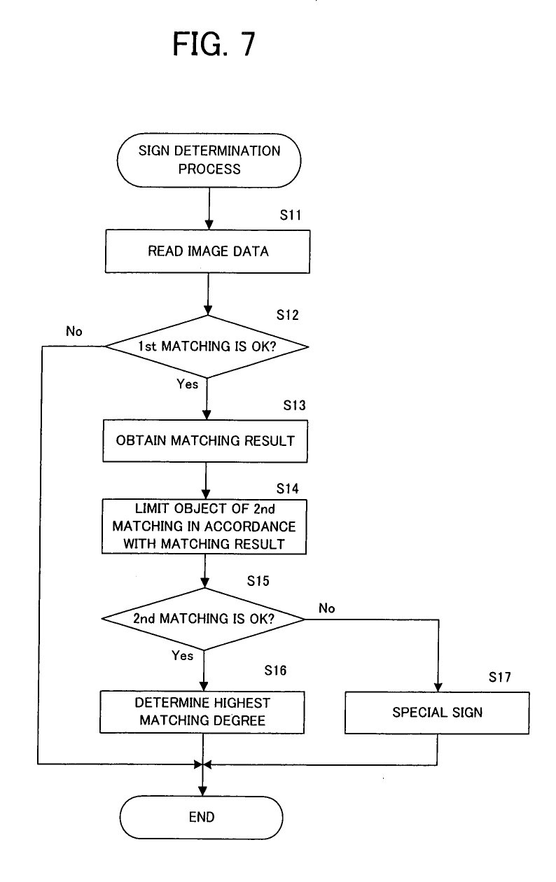

The sign determination unit 22 determines the road sign corresponding to each of the image data by the above-mentioned sign determination method. FIG. 7 shows a flow chart of the sign determination process. First, the sign determination unit 22 reads the image data from the image data storage unit 21 (step S11), and executes the first matching with using the basic template BT as described above (step S12). When the matching is not obtained by the first matching, the process ends. Meanwhile, when the matching is obtained, the matching result shown in FIG. 4 is obtained (step S13).

Next, the sign determination unit 22 limits the object of the second matching by the above-mentioned first and/or second methods based on the matching result (step S 14), and execute the second matching with using the sign template MT (step S15). When the matching equal to or larger than the predetermined level is established by the second matching (step S15; Yes), the road sign corresponding to the sign template with which the highest matching degree is obtained is determined as the road sign corresponding to the image data (step S16), and the process ends. Meanwhile, when the matching equal to or larger than the predetermined level is not established in any sign templates (step S15; No), the road sign corresponding to the image data is determined as the special sign, and the process ends. Other process, e.g., determination by a person, is executed to the image data determined as the special sign.

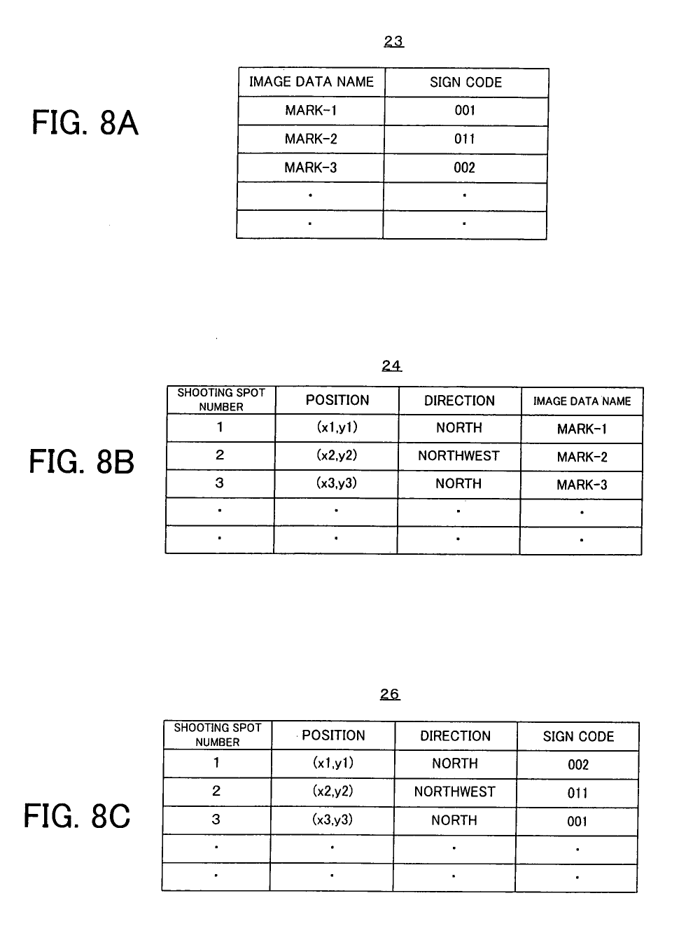

When the road sign is determined by the sign determination process, the image data and the sign code of the sign corresponding to the image data are associated with each other to be stored in the sign determination result storage unit 23. FIG. 8A shows a storage contents example of the sign determination result storage unit 23.

Next, the coordinate giving unit 25 obtains the traveling coordinate data from the traveling coordinate storage unit 24. FIG. 8B shows a storage contents example of the traveling coordinate storage unit 24. As shown, each of the image data shot by the field survey vehicle including the camera and information about a spot at which the image data is shot are associated with each other to be stored in the traveling coordinate storage unit 24. Concretely, a shooting spot number of each of the image data, a position thereof (longitude and latitude) and a traveling direction of the field survey vehicle at the spot are stored for each image data.

In addition, the coordinate giving unit 25 obtains the sign code corresponding to each of the image data from the sign determination result storage unit 23. By using the image data name as the key, the coordinate giving unit 25 associates each of the shooting spot number, the position, the traveling direction of the field survey vehicle at the spot and the sign code of the road sign existing at the spot with each other, and stores them in the sign information storage unit 26 as the sign information. FIG. 8C shows a storage contents example of the sign information storage unit 26.

As described above, the sign information relating to the road sign obtained by the field survey is produced with using the sign determination process of this embodiment. The sign information is used for map data, for example.

### [Modification]

In the above embodiment, the road sign is determined by executing the second matching with using the sign template after executing the first matching with using the basic template. Instead, the road sign may be determined with using only the first matching. In that case, as shown in FIG. 4, the shape of the road sign is determined with using both of the number of matching positions and the matching angle. Namely, since the number of matching positions indicates the number of arrows and the matching angle indicates the arrow direction, the sign “DO NOT ENTER OTHER THAN DESIGNED DIRECTION” having the number of arrows corresponding to the information and the direction thereof may be determined as the sign corresponding to the image data.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2006-182196 filed on Jun. 30, 2006 including the specification, claims, drawings and summary is incorporated herein by reference in its entirety.

What is claimed is:

1. A road sign determination apparatus comprising:
an image recognition unit which executes image recognition of image data of a road sign with using a prepared template; and
a determination unit which determines a road sign corresponding to the image data based on a result of the image recognition,
wherein the template includes a basic template formed by a figure formed by combining a circle of a sign frame and a single arrow.

2. The road sign determination apparatus according to claim 1,
wherein the image recognition unit includes:
a first matching unit which executes matching by relatively rotating the basic template by a predetermined angle with respect to the image data, and obtains matching results in plural angle areas; and
a second matching unit which executes matching with using a sign template corresponding to an actual road sign in accordance with the matching result.

3. The road sign determination apparatus according to claim 2,
wherein the second matching unit executes the matching with using the sign template only in the angle area in which the matching equal to or larger than a predetermined level is obtained in the matching result.

4. The road sign determination apparatus according to claim 2,
wherein the second matching unit limits the sign template used in the second matching based on a number of matching obtained in the matching result.

5. The road sign determination apparatus according to claim 1,
wherein the basic template includes plural templates having same circle sizes of the sign frames and different arrow sizes.

6. A road sign determination method comprising:
an image recognition step which executes image recognition of image data of a road sign with using a prepared template; and
a determination step which determines a road sign corresponding to the image data based on a result of the image recognition,
wherein the template includes a basic template formed by a figure formed by combining a circle of a sign frame and a single arrow.

7. A computer program product in a computer-readable medium executed in a road sign determination apparatus, the computer program product making a computer function as:
an image recognition unit which executes image recognition of image data of a road sign with using a prepared template; and
a determination unit which determines a road sign corresponding to the image data based on a result of the image recognition,
wherein the template includes a basic template formed by a figure formed by combining a circle of a sign frame and a single arrow.
